(19) United States
(12) Patent Application Publication
(10) Pub. No.: US 2015/0086132 A1
(43) Pub. Date: Mar. 26, 2015

(54) Image Processing Apparatus and Image Processing Method

(71) Applicant: CASIO COMPUTER CO., LTD., Shibuya-ku (JP)

(72) Inventor: Takeshi Tsukagoshi, Ome-shi (JP)

(73) Assignee: CASIO COMPUTER CO., LTD., Tokyo (JP)

(21) Appl. No.: 14/491,647

(22) Filed: Sep. 19, 2014

(30) Foreign Application Priority Data
Sep. 20, 2013 (JP) 2013-195901

(51) Int. Cl. H04N 5/232

(52) U.S. Cl. CPC H04N 5/23264
USPC 382/275

(57) ABSTRACT

The imaging device 1 includes an imaging unit 16 for taking an image, an image determination unit 54 for determining a position of a specific subject in the image, and a correction processing unit 55 for correcting the image such that, if the image determination unit 54 determines that the specific subject is positioned in an area other than the center of the image, the degree of correction of distortion due to lens aberration is stronger in the area other than the center of the image than in the center.

### CROSS-REFERENCE TO RELATED APPLICATIONS

This application is based upon and claims the benefit of priority under 35 USC 119 of Japanese Patent Application No. 2013-195901 filed on Sep. 20, 2013, the entire disclosure of which is hereby incorporated by reference in its entirety for all purposes.

### BACKGROUND OF THE INVENTION

1. Field of the Invention

The present invention relates to an image processing apparatus and an image processing method for correcting images.

2. Description of the Related Art

Conventionally, there is a technology for performing distortion correction to reduce distortion of images captured by a digital camera and the like, due to distortion aberration of imaging lenses, as described in Japanese Patent Application Laid-Open Publication No. 2011-128913. For example, a technology is disclosed for weakening the degree of distortion correction according to a position of an image of a subject within a photography range.

However, using the technology described in the above patent document, a user may not obtain a desired image by weakening distortion correction according to states in which a subject is imaged within a photography range.

### SUMMARY OF THE INVENTION

The present invention was made in light of the problem mentioned above, and an object of the present invention is to perform image correction suitable to a user's preference according to states in which a subject is imaged within a photography range.

According to a first aspect of the present invention, there is provided an image processing apparatus comprising an acquisition unit for acquiring an image, a first determination unit for determining a position of a specific subject in the image acquired by the acquisition unit, and a correction unit for correcting the image such that, if the first determination unit determines that the specific subject is positioned in an area other than the center of the image, the degree of correction of distortion due to lens aberration is stronger in the area other than the center of the image than in the center.

According to a second aspect of the present invention, there is provided an image correcting method comprising an acquisition step of acquiring an image, a determination step of determining a position of a specific subject in the image acquired at the acquisition step, and a correction step of correcting the image such that, if it is determined at the determination step that the specific subject is positioned in an area other than the center of the image, the degree of correction of distortion due to lens aberration is stronger in the area other than the center of the image than in the center.

The above and further objects and novel features of the present invention can be more fully understood from the following detailed description taken in conjunction with the accompanying drawings. It is to be expressly understood, however, that the drawings are for the purpose of illustration only and are not intended as a definition of the limits of the invention.

### BRIEF DESCRIPTION OF THE DRAWINGS

FIG. 1 is a block diagram showing a hardware configuration of an imaging device according to a first embodiment of an image processing apparatus of the present invention.

FIGS. 2A and 2B show drawings for explanation of an image correction method used in the present embodiment.

FIGS. 3A to 3C show images obtained by performing distortion correction to different degrees.

FIG. 4 is a functional block diagram showing functional elements for performing an image correction process of the imaging device of FIG. 1.

FIG. 5 is a flowchart showing an image correction process performed by the imaging device of FIG. 1 having the functional configuration shown in FIG. 4.

FIG. 6 is a flowchart showing another embodiment of an image correction process performed by the imaging device of FIG. 1 having the functional configuration shown in FIG. 4.

### DETAILED DESCRIPTION OF THE PREFERRED EMBODIMENT

Hereinafter, embodiments of the present invention will be described with reference to the drawings.

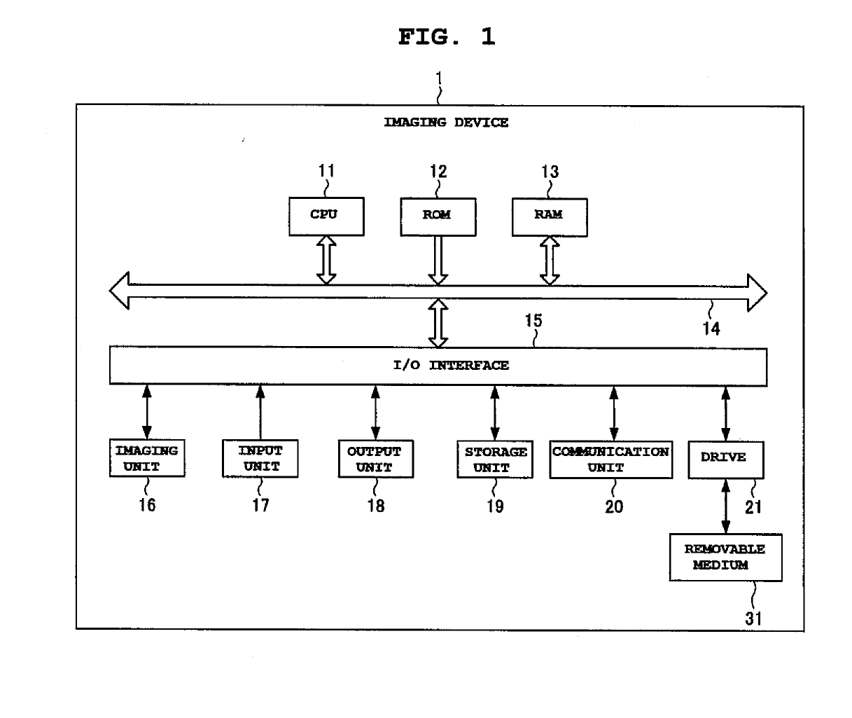

FIG. 1 is a block diagram showing a hardware configuration of an imaging device according to a first embodiment of an image processing apparatus of the present invention.

For example, the imaging device 1 is realized by a digital camera.

The imaging device 1 includes a CPU (Central Processing Unit) 11, ROM (Read Only Memory) 12, RAM (Random Access Memory) 13, a bus 14, an I/O interface 15, an imaging unit 16, an input unit 17, an output unit 18, a storage unit 19, a communication unit 20, and a drive 21.

The CPU 11 performs various processes in accordance with programs stored in the ROM 12 or loaded in the RAM 13 from the storage unit 19.

In the RAM 13, there are stored data necessary for the CPU 11 to perform various processes, and the like.

The CPU 11, the ROM 12 and the RAM 13 are connected to each other via the bus 14. The I/O interface 15 is also connected to the bus 14. The imaging unit 16, the input unit 17, the output unit 18, the storage unit 19, the communication unit 20, and the drive 21 are connected to the I/O interface 15.

The imaging unit 16 includes an optical lens unit and an image sensor (not shown in the drawing).

The optical lens unit includes lenses for collecting light to photograph a subject, for example, a focus lens, a zoom lens, and the like.

The focus lens forms an image of a subject on a light-receiving surface of the image sensor. The zoom lens freely changes the focal length within a predetermined range.

Further, the optical lens unit is provided with a peripheral circuit to adjust setting parameters such as focusing, exposure, white balancing, and the like, as necessary.

The image sensor includes a photoelectric conversion element, an AFE (Analog Front End), and the like.

The photoelectric conversion element includes a CMOS (Complementary Metal Oxide Semiconductor) type photoelectric conversion element, for example. A subject's image is input to the photoelectric conversion element from the optical lens unit. The photoelectric conversion element performs of photoelectric conversion (image capturing) of the subject's image and accumulates image signals for a predetermined period of time. The photoelectric conversion element provides the AFE with the accumulated image signals sequentially.

The AFE performs various signal processing operations such as A/D (Analog/Digital) conversion, and the like, on the analog image signals. Digital signals are generated by the signal processing operations and output as output signals of the imaging unit 16.

The output signals are hereinafter referred to as “image data”. The image data is supplied to the CPU 11, an image processing unit (not shown in the drawing), or the like.

The input unit 17 includes various buttons and a variety of information is input via the input unit 17 in response to a user's operations.

The output unit 18 includes a display device, a speaker, or the like, and outputs images or voices.

The storage unit 19 includes a hard disk, a DRAM (Dynamic Random Access Memory), or the like and various image data is stored in the storage unit 19.

The communication unit 20 controls communication with other devices (not shown in the drawing) via a network such as Internet.

A removable medium 31 including a magnetic disk, an optical disk, a semiconductor disk, or the like, is mounted on the drive 21. A program read out from the removable medium 31 by the drive 21 is installed in the storage unit 19. Similarly to the storage unit 19, the removable medium 31 stores various data such as the image data stored in the storage unit 19.

The imaging device 1 having the configuration described above has a function of performing a correction process for an acquired image. The correction process according to the present embodiment is performed considering a state in which a subject is imaged. Specifically, the correction process changes the degree of image correction with consideration of whether a subject's face is imaged and/or the position of the face.

Hereinafter, image correction used in the present embodiment will be explained.

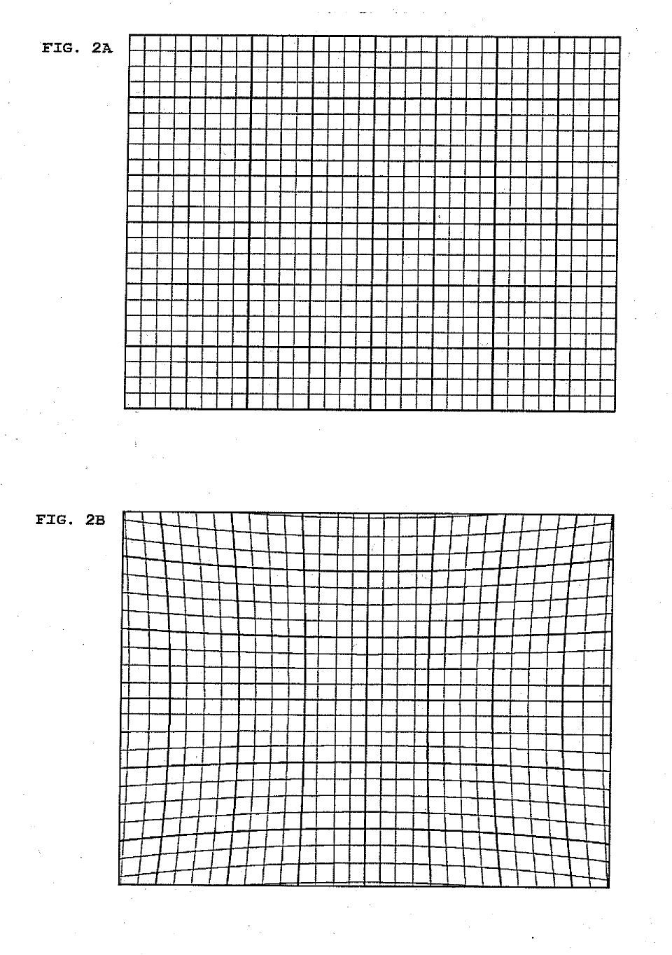

FIGS. 2A and 2B show drawings for explanation of the image correction used in the present embodiment.

The image correction uses methods for correcting distortion aberration of a camera lens (hereinafter, referred to as “distortion correction”).

The distortion correction corrects distortion aberration of a camera lens and more specifically, corrects distortion making sides of an image swell like a barrel (hereinafter, referred to as “barrel distortion”) to make the image have no distortion as shown by grid lines in FIG. 2A. To make an image with the barrel distortion have no distortion as shown in FIG. 2A, the correction of a shape as shown in FIG. 2B is performed such that the sides of the image are warped toward to the center of the image and areas of the four corners of the image are stretched, reversely to the shape of the barrel distortion. Further, in the distortion correction, the more far from the center of the image, the stronger the degree of the distortion correction becomes.

Further, the image processing of the present embodiment changes the strength of the distortion correction according to states of a subject of the image.

In the case of performing distortion correction of which degree is stronger than usual, image correction for warping an image in a shape as shown in FIG. 2B is performed such that the sides of the image are warped toward the center of the image and areas of the four corners of the image are stretched. In the case of strengthening the degree of the distortion correction like this, there is achieved an effect that a face is warped and looks small if the centerline of the face is in a radial direction from the center of the image. More specifically, the face is stretched more as the magnitude of the image height is larger by the distortion correction. Thus, as the face becomes slim and the lower part of the face becomes smaller than the top of the head, the effect that the face looks small occurs. Although the small face effect is also achieved when the face exists in any of areas of the four corners of the image, the balance of the face may be disturbed unevenly under this condition. In order to prevent this situation, it can be added to the conditions for the distortion correction that the centerline of the face is aligned in a radial direction from the center of the image.

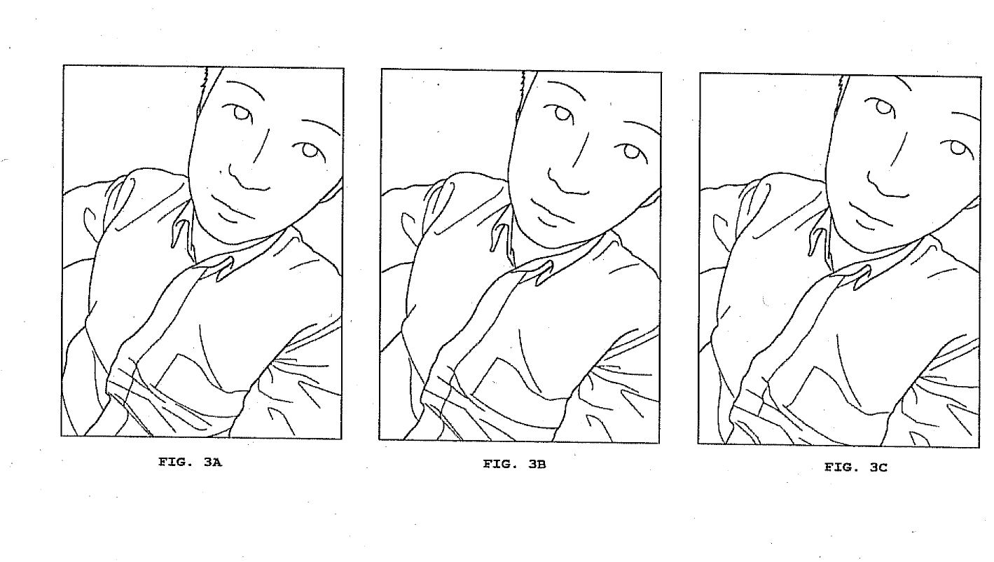

Here, the term of “small face” used herein includes the concept that a ratio of the upper part to the lower part or the lower part to the upper part of a face changes to a higher or lower value (for example, the jaw becomes smaller relatively to the forehead than before the correction) as well as the concept that the whole size of a face reduces. Further, the areas of the four corners of an image where the small face effect can occur through the distortion correction includes, for example, an area occupying 50% from one of the corners to the center of the image when the forehead of a face contacts with the corner and the jaw of the face is in the center of the image as shown in FIGS. 3A to 3C.

In the present embodiment, the distortion correction providing the small face effect as described above is referred to as a first correction. In comparison, distortion correction usually used is referred to as a usual correction.

In the case of performing distortion correction of which degree is weaker than usual, image correction for warping an image in a shape as shown in FIG. 2B is performed such that warping from the sides toward the center of the image is weakened and stretch of the areas of the four corners of the image is weakened. In the case of weakening the degree of the distortion correction like this, distortion of a subject in the edge of the image can also be reduced. Thus, distortion due to aberration of a camera lens is suppressed and, at the same time, distortion of each of subjects is reduced over the whole image. Using this principle, when there exist faces in the whole of an image including the center and the edge (e.g. a group photograph), an effect that the balance of size of each of the faces all over the image is not disturbed can be achieved.

According to the present embodiment, the distortion correction suitable to a group photograph, which has the effect that the balance of size of each face over the whole image is not disturbed is achieved as described above, is referred to as a second correction.

FIGS. 3A to 3C show images obtained by performing distortion correction to different degrees.

In the examples of FIGS. 3A-C, distortion correction is performed for an image in which a face exists in an area of the upper right corner while changing the degree of distortion correction.

In the example of FIG. 3A, the second correction of which degree of correction is the weakest is performed. In the example of FIG. 3B, the usual correction is performed. In the example of FIG. 3C, the first correction of which degree of correction is the strongest is performed. In other words, FIGS. 3A-C show three images in the order of strength of correction from FIGS. 3A to 3C.

In comparison of FIG. 3C with FIGS. 3A and 3B, it is understood that the face in FIG. 3C is narrow to be a small face.

Further, the small face effect is the greatest for an image photographed with a camera held vertically such that the longer side of the image is in the vertical direction in order to place the center line of a face approximately in a radial direction from the center of the image, and in which the face is in one of the areas of the four corners of the image and the center line of the face is located radially from the center of the image.

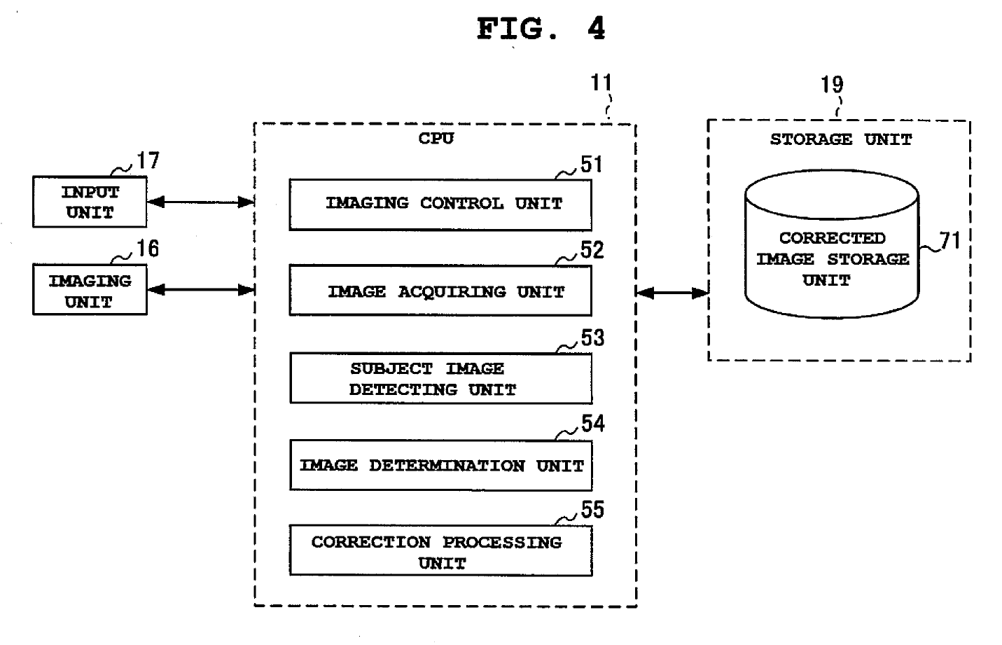

FIG. 4 is a functional block diagram showing functional elements for performing an image correction process of the imaging device of FIG. 1.

The image correction process means a process for performing image correction to an achieved image according to a state of a face detected from the image.

For the image correction process, an imaging control unit 51, an image acquiring unit 52, a subject image detecting unit 53, an image determination unit 54, and a correction processing unit 55 function in the CPU 11 as described in FIG. 4.

Further, a corrected image storage unit 71 is configured in an area of the storage unit 19.

In the corrected image storage unit 71, corrected image data is stored.

The imaging control unit 51 receives imaging operations from the input unit 17 and controls the imaging unit 16 to perform an imaging process.

The image acquiring unit 52 acquires an image output from the imaging unit 16. The image acquiring unit 52 outputs the acquired image to the subject image detecting unit 53 as an image to be corrected (hereinafter, referred to as a “target image”).

The subject image detecting unit 53 detects a face from the acquired target image. One of the conventional technologies is used for the face detection.

When a face is detected by the subject image detecting unit 53, the image determination unit 54 determines a position of the face in the image. Specifically, the image determination unit 54 determines as the face's position whether the center line of the face is in the radial direction from the center of the target image.

The correction processing unit 55 performs a correction process to a target image according to the detection by the subject image detecting unit 53 and/or the determination by the image determination unit 54.

Specifically, the correction processing unit 55 performs the usual correction if no face is detected from the target image, or if no face exists in any of the areas of the four corners of the image.

Further, the correction processing unit 55 performs a process for the first correction if there is a face in any of the areas of the four corners of the image. Furthermore, if there is a face in any of the areas of the four corners of the image and a ratio of the face to the whole image is higher than a predetermined value, the first correction is performed more definitely because there is a strong possibility that the image is a self-portrait photograph or a portrait. On the other hand, if the ratio of the face to the whole image is lower than a predetermined value, the second correction may be performed because there is a strong possibility that the image is a group photograph.

The correction processing unit 55 performs a process for the second correction if there are faces in an area other than the areas of the four corners as well as in the areas of the four corners and the image is photographed with the imaging device 1 held horizontally such that the longer side of the image is in the horizontal direction.

After performing the correction process, the correction processing unit 55 makes the image which has been corrected (hereinafter, referred to as a “corrected image”) in the corrected image storage unit 71.

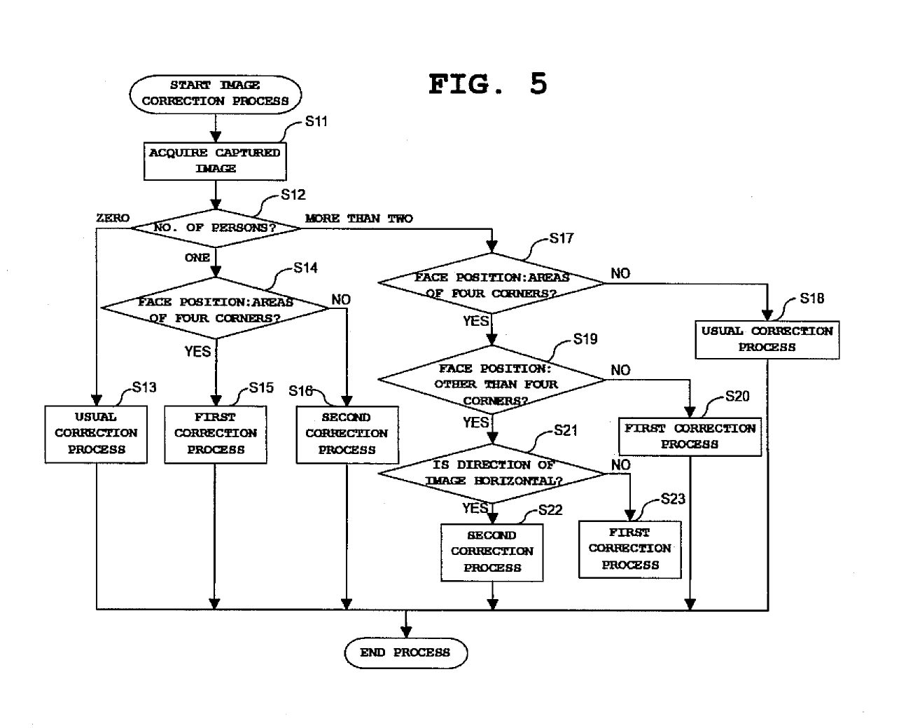

FIG. 5 is a flowchart showing an image correction process performed by the imaging device of FIG. 1 having the functional configuration shown in FIG. 4. The image correction process is started by an image correction process starting operation input to the input unit 17 by a user. Then, by a capturing operation input to the input unit 17 by the user, the imaging control unit 51 controls the imaging unit 16 to perform an image capture process.

At Step S11, the image acquiring unit 52 acquires an image captured by the imaging unit 16. The image acquiring unit 52 outputs the acquired image to the subject image detecting unit 53 as a target image.

At Step S12, the subject image detecting unit 53 counts the number of faces in the image.

If the number of faces is zero, the determination at Step S12 is “zero” and the process proceeds to Step S13.

If the number of faces is one, the determination at Step S12 is “one” and the process proceeds to Step S14.

If the number of faces is two, the determination at Step S12 is “two” and the process proceeds to Step S17. The steps following Step S14 will be described later.

At Step S13, the correction processing unit 55 performs the usual correction.

As a result, the correction processing unit 55 generates an image to which the usual distortion correction has been performed. Thus, it is possible to generate an image which is not affected by lens aberration.

Further, after performing the correction, the correction processing unit 55 makes the corrected image be stored in the corrected image storage unit 71. Then, the image correction process is ended.

At Step S14, the image determination unit 54 determines whether a face is positioned in any of the areas of the four corners of the image.

If a face exists in any of the areas of the four corners of the image, the determination at Step S14 is “YES” and the process proceeds to Step S15.

At Step S15, the correction processing unit 55 performs the first correction. Specifically, a corrected image is generated to which distortion correction stronger than the usual distortion correction has been performed. Thus, it is possible to generate an image in which a face looks slimmer than one in an image to which the usual distortion correction has been performed, as shown in FIG. 3C. Further, the image determination unit 54 may determine the size of the face. If a ratio of the face to the whole image is high, the first correction is performed more definitely because there is a strong possibility that the image is a self-portrait photograph or a portrait. If the ratio of the face to the whole image is low, the usual correction or the second correction can be performed.

Further, after performing the correction, the correction processing unit 55 makes the corrected image be stored in the corrected image storage unit 71. Then, the image correction process is ended.

On the other hand, if no face exists in any of the areas of the four corners of the image, the determination at Step S14 is “NO” and the process proceeds to Step S16.

At Step 16, the correction processing unit 55 performs the second correction. Specifically, a corrected image is generated to which distortion correction weaker than the usual distortion correction has been performed and of which edges have been stretched slightly. Thus, it is possible to generate an image in which image quality is not different between faces in the center and an edge.

Further, after performing the correction, the correction processing unit 55 makes the corrected image be stored in the corrected image storage unit 71. Then, the image correction process is ended.

At Step S17, the image determination unit 54 determines whether a face is positioned in any of the areas of the four corners of the image.

If no face exists in any of the areas of the four corners of the image, the determination at Step S17 is “NO” and the process proceeds to Step S18.

If a face exists in any of the areas of the four corners of the image, the determination at Step S17 is “YES” and the process proceeds to Step S19. The steps following Step S19 will be described later.

At Step S18, the correction processing unit 55 performs the usual correction.

As a result, the correction processing unit 55 generates a corrected image to which the usual correction has been performed. In other words, an image to which the usual distortion correction has been performed is generated. Thus, it is possible to generate an image which is not affected by lens aberration.

Further, after performing the correction, the correction processing unit 55 makes the corrected image be stored in the corrected image storage unit 71. Then, the image correction process is ended.

At Step S19, the image determination unit 54 determines whether a face is positioned in an area other than the areas of the four corners of the image.

If no face exists in an area other than of the areas of the four corners of the image, the determination at Step S19 is “NO” and the process proceeds to Step S20.

If a face exists in an area other than the areas of the four corners of the image, the determination at Step S19 is “YES” and the process proceeds to Step S21. The steps following Step S21 will be described later.

At Step 20, the correction processing unit 55 performs the first correction. Specifically, a corrected image is generated to which distortion correction stronger than the usual distortion correction has been performed. Thus, it is possible to generate an image in which a person's face looks slimmer than one in an image to which the usual distortion correction has been performed, as shown in FIG. 3C. Further, the image determination unit 54 may determines the size of the face. If a ratio of the face to the whole image is high, the first correction is performed more definitely because there is a strong possibility that the image is a self-portrait photograph or a portrait. If the ratio of the face to the whole image is low, the usual correction or the second correction can be performed.

Further, after performing the correction, the correction processing unit 55 makes the corrected image be stored in the corrected image storage unit 71. Then, the image correction process is ended.

At Step 21, the image determination unit 54 determines whether the direction of the image is horizontal or not.

In other words, the image determination unit 54 determines whether the image has been photographed with the imaging device 1 held horizontally or vertically.

If the direction of the image is horizontal, the determination at Step S21 is “YES” and the process proceeds to Step S22.

At Step 22, the correction processing unit 55 performs the second correction. Specifically, a corrected image is generated to which distortion correction weaker than the usual distortion correction has been performed and of which edges have been stretched slightly. Thus, it is possible to generate a natural image in which image quality is not different between faces in the center and an edge.

Further, after performing the correction, the correction processing unit 55 makes the corrected image be stored in the corrected image storage unit 71. Then, the image correction process is ended.

On the other hand, if the direction of the image is vertical, the determination at Step S21 is “NO” and the process proceeds to Step S23.

At Step S23, the correction processing unit 55 performs the first correction.

Thus, the correction processing unit 55 generates a corrected image to which the first correction has been performed. Specifically, an image is generated in which a person's face looks slimmer than one in an image to which the usual distortion correction has been performed.

Further, after performing the correction, the correction processing unit 55 makes the corrected image be stored in the corrected image storage unit 71. Then, the image correction process is ended.

### Another Embodiment

The first embodiment is configured to change the kind of image correction to be performed to an image according to whether or not a face exists in the image, a face's position in the image (whether a face is positioned in any of the areas of the four corners of the image or whether a face exists only in any of the areas of the four corners of the image), and/or the direction of the image. A second embodiment is configured to change the kind of image correction to be performed to an image according to whether or not a face exists in the image and/or a face's position in the image (whether the center line of a face is positioned in a radial direction from the center of the image).

For the second embodiment described in the following, explanation of features similar to the first embodiment will be omitted. In other words, explanation of some part of hardware and functional blocks is omitted.

The distortion correction has the effect that a face looks slim under the condition of the first embodiment (the condition that the face exists only in any of the areas of the four corners of the image). But, in some cases, the face is warped unnaturally under the condition. This can be avoided by adding it as a condition that the centerline of the face is aligned in a radial direction from the center of the image. Specifically, the face is stretched more as the magnitude of the image height is larger by the distortion correction. Thus, as the face becomes slim and the lower part of the face becomes smaller than the top of the head, the effect that the face looks small is obtained.

As shown in FIG. 4, the correction processing unit 55 performs correction according to the detection result of the subject image detecting unit 53 and the determination result of the image determination unit 54. Specifically, the correction processing unit 55 performs the usual correction to a target image if no face is detected in the target image. If a face is detected in a target image and the center line of the face is aligned in a radial direction from the center of the target image, the correction processing unit 55 performs the first correction to the target image. If a face is detected in a target image and the center line of the face is not aligned in a radial direction from the center of the target image, the correction processing unit 55 performs the second correction to the target image.

Further, after performing the correction, the correction processing unit 55 makes the image to which the correction is performed (hereinafter, referred to as a “corrected image”) be stored in the corrected image storage unit 71.

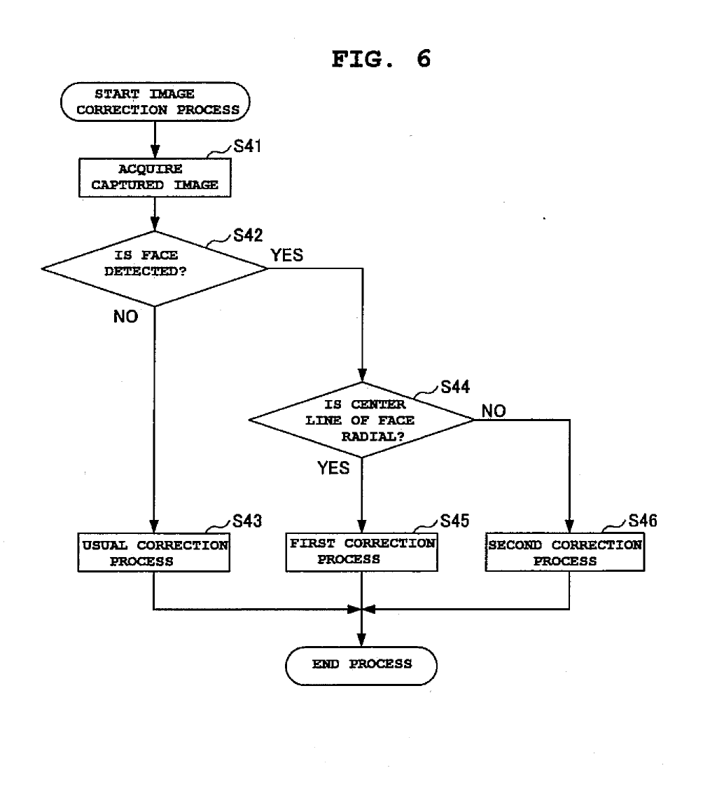

FIG. 6 is a flowchart showing another embodiment of an image correction process performed by the imaging device of FIG. 1 having the functional configuration shown in FIG. 4.

At Step S41, the image acquiring unit 52 acquires an image. The image acquiring unit 52 outputs the acquired image to the subject image detecting unit 53 as a target image.

At Step S42, the subject image detecting unit 53 determines whether a face is detected from the target image.

If a face is detected, the determination at Step S42 is “YES” and the process proceeds to Step S44.

If no face is detected, the determination at Step S42 is “NO” and the process proceeds to Step S43.

At Step S43, the correction processing unit 55 performs the usual correction to the target image because no face is detected from the target image.

As a result, the correction processing unit 55 generates an image to which the usual correction has been performed. Specifically, an image to which the usual distortion correction has been performed is generated. Thus, it is possible to generate an image which is not affected by lens aberration.

Then, after performing the correction, the correction processing unit 55 makes the corrected image be stored in the corrected image storage unit 71.

At Step S44, as a face is detected from the target image, the image determination unit 54 determines whether the center line of the face is aligned in a radial direction.

If the centerline of the face is aligned in a radial direction, the determination at Step S44 is “YES” and the process proceeds to Step S45.

If the center line of the face is not aligned in a radial direction, the determination at Step S44 is “NO” and the process proceeds to Step S46.

At Step S45, the correction processing unit 55 performs the first correction. Specifically, a corrected image is generated to which distortion correction stronger than the usual distortion correction has been performed. Thus, it is possible to generate an image in which a face looks slimmer than one in an image to which the usual distortion correction has been performed, as shown in FIG. 3C.

Then, after performing the correction, the correction processing unit 55 makes the corrected image be stored in the corrected image storage unit 71.

At Step S46, the correction processing unit 55 performs the second correction. Specifically, a corrected image is generated to which distortion correction weaker than the usual distortion correction has been performed and of which edges have been stretched slightly. Thus, it is possible to generate an image in which image quality is not different between faces in the center and an edge.

Then, after performing the correction, the correction processing unit 55 makes the corrected image be stored in the corrected image storage unit 71.

The imaging device 1 configured as above includes an image determination unit 54, an image acquiring unit 52 and a correction processing unit 55.

The image acquiring unit 52 acquires an image.

The image determination unit 54 determines a position of a specific subject in the image acquired by the image acquiring unit 52.

If the image determination unit 54 determines that the specific subject is in an area other than the center of the image, the correction processing unit 55 corrects the image such that the degree of correction of distortion due to lens aberration is stronger in areas other than the center of the image than in the center.

Thus, the imaging device 1 can perform correction proper to a state of a subject within a photography range.

Further, the image determination unit 54 determines the direction of the image in which the subject is captured. If the image determination unit 54 determines that the direction of the image is vertical, the correction processing unit 55 performs the first correction such that the degree of correction is stronger in areas other than the center of the image than in the center.

Thus, the imaging device 1 can perform correction proper to a state in which a subject is imaged within a photography range.

Further, if the image determination unit 54 determines that the direction of the image is horizontal, the correction processing unit 55 performs the usual correction or the second correction such that the degree of correction is weaker in areas other than the center of the image than in the center.

Thus, the imaging device 1 can perform correction proper to a state in which a subject is imaged within a photography range.

Further, the image determination unit 54 determines whether the center line of the subject is in a radial direction from the center of the image.

If the image determination unit 54 determines that the center of the subject is located on a radial line extended from the center of the image, the correction processing unit 55 performs the first correction such that the degree of correction is stronger in areas other than the center of the image than in the center. If the image determination unit 54 determines that the center line of the subject is not located on a radial line extended from the center of the image, the correction processing unit 55 performs the usual correction or the second correction such that the degree of correction is weaker in areas other than the center of the image than in the center.

Thus, the imaging device 1 can perform correction proper to a state in which a subject is imaged within a photography range.

Further, the image determination unit 54 determines the size of the subject in the image.

Based on the determination of the image determination unit 54, the correction processing unit 55 corrects the image such that the degree of correction is stronger in areas other than the center of the image than in the center. For example, if a ratio of a face to the whole image is high, the image processing unit 55 performs the first correction because there is a strong possibility that the image is a self-portrait photograph or a portrait. If the ratio of the face to the whole image is low, the image processing unit 55 performs the second correction because there is a strong possibility that the image is a group photograph.

Thus, the imaging device 1 can perform correction proper to a state in which a subject is imaged within a photography range.

Further, the imaging device 1 includes a subject image detecting unit 53 for counting the number of subjects in the image.

Based on the detection of the subject image detecting unit 53, the correction processing unit 55 corrects the image such that the degree of correction is stronger in areas other than the center of the image than in the center. For example, if the number of faces is small, the image processing unit 55 performs the first correction because there is a strong possibility that the image is a self-portrait photograph or a portrait. If the number of faces is large, the image processing unit 55 performs the second correction because there is a strong possibility that the image is a group photograph.

Thus, the imaging device 1 can perform correction proper to a state in which subjects are imaged within a photography range.

Further, the invention is not limited to the embodiments described above and any modifications or alternatives which can achieve the object of the invention fall within the scope of the invention.

In the particular embodiment described above, when performing the first correction to an image, the farther from the center of the image an area is, the stronger the degree of distortion correction is in the area. In some embodiments, it is sufficient that the degree of distortion correction is stronger in any area other than the center of the image than in the center. For this, the degree of correction may be strengthened proportionally to the distance from the center or in a position of which distance from the center is larger than a threshold value. Further, by setting a plurality of threshold values according to distances from the center, it is possible to strengthen the degree of correction by stages.

Further, although the embodiment described above is configured to perform the first correction in Step S23, the usual correction can be performed instead of the first correction. By this, when faces exist in an area other than the areas of the four corners as well as in the areas of the four corners of the image, it is possible to perform image correction considering the face existing near any of the areas of the four corners.

Further, in the embodiments described above, the present invention has been applied to a digital camera as an example of the imaging device 1 without limitation.

For example, the present invention can be applied to general electronic devices having an image correction function. Specifically, the present invention can be applied to a notebook type personal computer, a printer, a television, a video camera, a portable navigation device, a mobile phone, a smart phone, a portable game device, and the like.

The sequences of the processes described above can be executed by hardware or software.

In other words, the functional configuration shown in FIG. 4 is merely an example and the present invention is not limited thereto. The imaging device 1 suffices if it has a function for performing a sequence of the steps as a whole. Functional blocks to use to implement this function are not limited to the embodiment of FIG. 4.

In addition, a functional block may be configured by a piece of hardware, a piece of software, or their combination.

In the case that the sequence of the steps is performed by software, a program configuring the software is installed in a computer or the like from a network or a storage medium.

The computer may be a computer which is incorporated in dedicated hardware. In addition, the computer may be a computer capable of executing various functions by installing various programs therein, for example, a general-purpose personal computer.

1.-7. (canceled)

8. An image processing apparatus comprising:
an acquisition unit for acquiring an image;
a first determination unit for determining a position of a specific subject in the image acquired by the acquisition unit; and
a correction unit for correcting the image such that, when the first determination unit determines that the specific subject is positioned in an area other than the center of the image, the degree of correction of distortion due to lens aberration is stronger in the area other than the center of the image than in the center.

9. The image processing apparatus according to claim 1, further comprising:
a second determination unit for determining a direction of an image capturing unit at a time of capturing the subject;
wherein the correction unit corrects the image such that the degree of the correction is stronger in any area other than the center of the image than in the center when the second determination unit determines that the direction is vertical.

10. The image processing apparatus according to claim 9, wherein the correction unit corrects the image such that the degree of the correction is weaker in any area other than the center of the image than in the center when the second determination unit determines that the direction is horizontal.

11. The image processing apparatus according to claim 8, further comprising:
a third determination unit for determining whether the center of a specific subject in the image acquired by the acquisition unit is located on a radial line extended from the center of the image;
wherein the correction unit corrects the image such that the degree of the correction is stronger in any area other than the center of the image than in the center when the third determination unit determines that the center of the specific subject in the image is located on a radial line extended from the center of the image, and, the degree of the correction is weaker in any area other than the center of the image than in the center when the third determination unit determines that the center line of the specific subject in the image is not located on a radial line extended from the center of the image.

12. The image processing apparatus according to claim 8, further comprising:
a fourth determination unit for determining the size of the subject in the image;
wherein the correction unit corrects the image such that the degree of the correction is stronger in any area other than the center of the image than in the center based on the determination of the fourth determination unit.

13. The image processing apparatus according to claim 8, further comprising:
a count unit for counting the number of subjects in the image;
wherein the correction unit corrects the image such that the degree of the correction is stronger in any area other than the center of the image than in the center based on the number counted by the count unit.

14. An imaging processing method using an image processing apparatus, comprising:
an acquisition step of acquiring an image;
a determination step of determining a position of a specific subject in the image acquired at the acquisition step; and
a correction step of correcting the image such that, when it is determined at the determination step that the specific subject is positioned in an area other than the center of the image, the degree of correction of distortion due to lens aberration is stronger in the area other than the center of the image than in the center.
